(19) United States
(12) Patent Application Publication
(10) Pub. No.: US 2017/0227247 A1
(43) Pub. Date: Aug. 10, 2017

(54) THERMAL MANAGEMENT DOOR ASSEMBLY

(71) Applicant: HEWLETT PACKARD ENTERPRISE DEVELOPMENT LP, Houston, TX (US)

(72) Inventors: James Anthony OLIVER, Houston, TX (US); James Jeffery SCHULZE, Houston, TX (US); Davis Matthew CASTILLO, Houston, TX (US)

(21) Appl. No.: 15/329,546

(22) PCT Filed: Aug. 29, 2014
(86) PCT No.: PCT/US2014/053383

§ 371 Date: Jan. 26, 2017

(51) Int. Cl. F24F 11/00; F24F 11/053; G06F 1/20; G05B 15/02

(52) U.S. Cl. CPC F24F 11/0079; G05B 15/02; F24F 11/053; G06F 1/206

(57) ABSTRACT

Example implementations relate to a thermal management door assembly. One example apparatus includes a first fan assembly including an intake region and an exhaust region. The apparatus also includes a second fan assembly aligned with the first fan assembly. The apparatus further includes a thermal management door assembly positioned between the first fan assembly and the second fan assembly. The thermal management door assembly includes a frame coupled to the first fan assembly and to the second fan assembly. The thermal management door assembly also includes a sealing door movably coupled to the frame to control an amount of air recirculation from the exhaust region to the intake region.

### BACKGROUND

Fans may be used to provide active cooling of components, such as memory modules and processors, inside a chassis of a computing device. Fans may be used to draw in air outside of a chassis to lower the air temperature inside the chassis. Fans may also be used to expel hot air inside the chassis to lower the air temperature inside the chassis.

### BRIEF DESCRIPTION OF THE DRAWINGS

Some examples of the present application are described with respect to the following figures:

FIG. 1 is a front view of a thermal management dear assembly, according to an example;

FIG. 2 is a back view of the thermal management door assembly of FIG. 1, according to an example:

FIG. 3A is a front view of the thermal management door assembly of FIG. 1 with a sealing door in a closed position, according to an example;

FIG. 3B is a front view of the thermal management door assembly of FIG. 1 with a sealing door in an open position, according to an example;

FIG. 4 illustrates an amount of air recirculation when the thermal management door assembly of FIG. 1 with a sealing door in a closed position, according example.

### DETAILED DESCRIPTION

As described above, fans may be used to provide active cooling of components inside a chassis of a computing device, such as a server computer. However, some of the hot air inside the chassis may spread to regions where the fans draw in air to reduce the temperature inside the chassis. The hot air is drawn in by the fan and is recirculated inside the chassis. Thus, the effectiveness of the fans is reduced.

Examples described herein provide a thermal management door assembly to control an amount of hot air recirculation inside a chassis of a computing device. For example, a thermal management door assembly may include a frame positioned between a first fan and a second fan assembly. The thermal management door assembly may include a sealing door movably coupled to the frame to control an amount of air recirculation from exhaust regions of the fan assemblies to intake regions of the fan assemblies. In this manner, examples described herein may reduce an amount of hot air recirculation inside a chassis of a computing device.

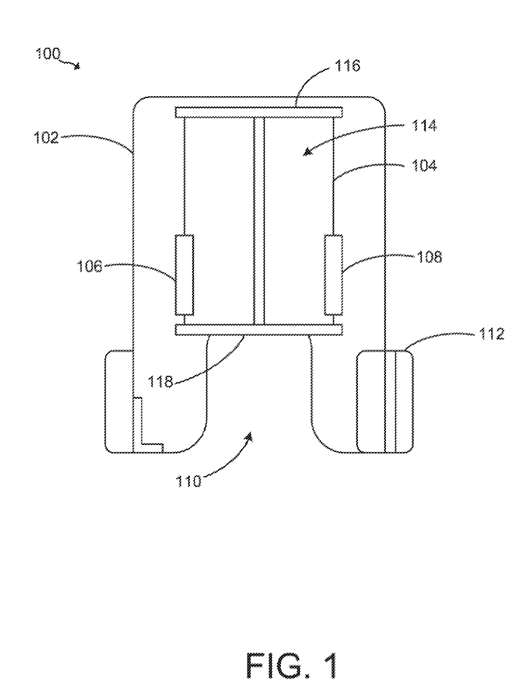

Referring now to the figures, FIG. 1 is a front view of a thermal management door assembly 100, according to an example. Thermal management door assembly 100 may include a frame 102 and a sealing door 104 movably coupled to frame 102. Frame 102 may include a plurality of retaining tabs, such as retaining tabs 106-108 to retain sealing door 104. In some examples, retaining tabs 106-108 may be L-shaped. Frame 102 may also include an opening 110. Frame 102 may further include a first receptacle 112 to receive an attachment mechanism from a chassis of a computing device.

Sealing door 104 may include a body region 114. Body region 114 may have dimensions (e.g., height and width) that are equal to or greater than dimensions of opening 110. Thus, sealing door 104 may control an amount of air recirculation between two fan modules by varying the amount of exposed space in opening 110 that is covered/blocked by sealing door 104. For example, when sealing door 104 is in a closed position, sealing door 104 may at least partially cover opening 110. Thus, opening 110 may have a first amount of exposed space. In some examples, open 110 may not nave any exposed space when sealing door 104 is in the closed position. When sealing door 104 is in an open position, opening 110 may have a second amount of exposed space that is greater than the first amount of exposed space.

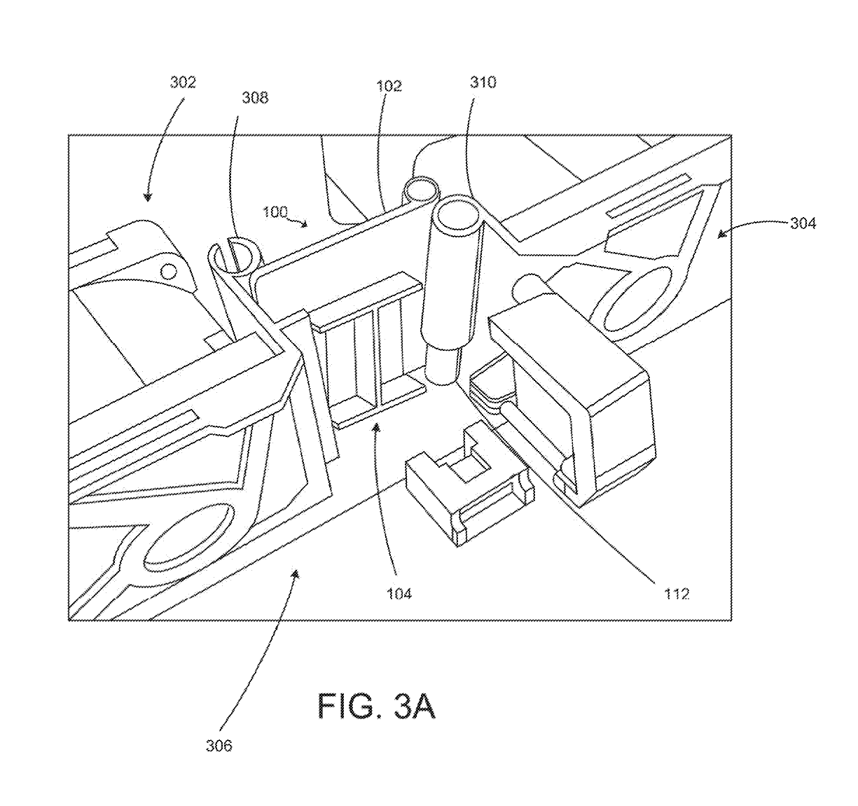

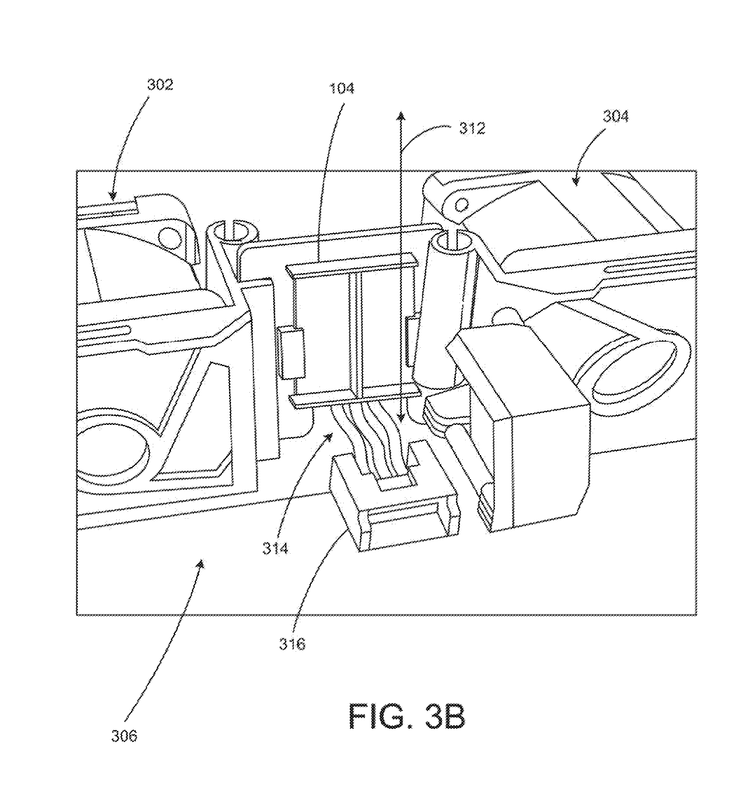

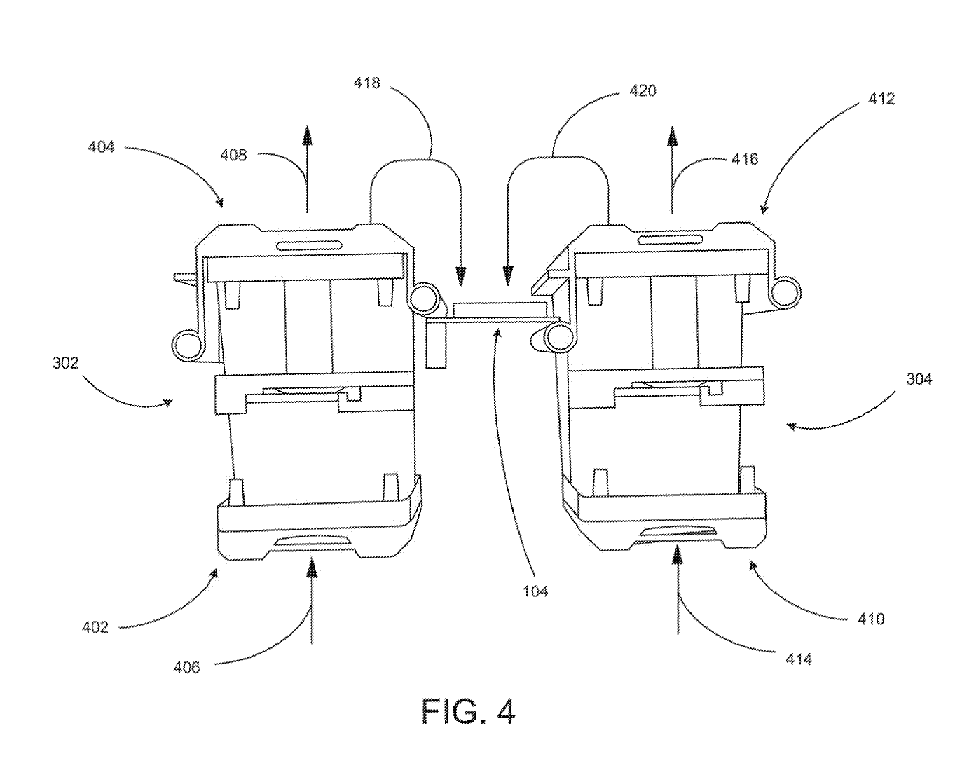

Sealing door 104 may also include a first flange 116 and a second flange 118 extending from body region 114. Flanges 116-118 may be dimensioned to come into contact with retaining tabs 106-108 to control movement of sealing door 104. The operation of sealing door 104 is described in more detail with reference to FIGS. 3A-3B and 4A-4B.

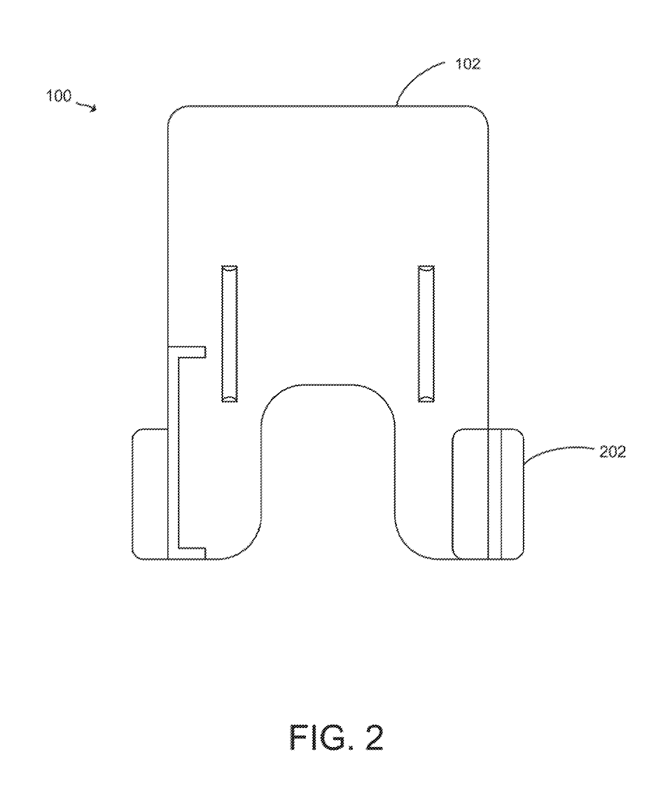

FIG. 2 is a back view of thermal management door assembly 100 of FIG. 1, according to an example. Thermal management door assembly 100 may include a second receptacle 202 to receive an attachment mechanism from a chassis of a computing device. Second receptacle 202 may extend from frame 102 in an opposite direction of first receptacle 112. As illustrated in FIG. 1, retaining tabs 106-108 and sealing door 104 may be located on the front side of frame 102. However, it should be understood that retaining tabs 106-108 and sealing door 104 may also be located on the back side of frame 102.

FIG. 3A is a front view of thermal management door assembly 100 with sealing door 104 in a dosed position, according to an example. During operation, thermal management door assembly 100 may be positioned between two fan modules 302-304 such that frame 102 is in physical contact with regions of fan modules 302-304 to reduce an amount of through space. Thermal management door assembly and fan modules 302-304 may be retained to a basepan 306. In some examples, basepan 306 may be part of a chassis.

In some examples, thermal management door assembly and fan modules 302-304 may be retained to basepan 306 via pins (not shown in FIG. 3A) extending from base an 306. A first pin may be used to retain fan module 302 via a receptacle 308 of fan module 302 and a second pin may be used to retain fan module 304 via a receptacle 310 of fan module 304. The first pin and the second pin may be in a staggered configuration to receive receptacles 112 and 202 (not shown in FIG. 3A). As illustrated in FIG. 3A, sealing door 104 is in a closed position so that opening 110 is covered/blocked by sealing door 104. In some examples, the movements of sealing door 104 may be passive. Thus, when sealing door 104 is in the closed position, pressure differential across fan modules 302-304 and gravity may help sealing door 104 remain at the closed position.

FIG. 3B is a front view of thermal management door assembly 100 with sealing door 104 in an open position, according to an example. During operation, sealing door 104 may be moved (e.g., by a user) with respect to an axis 12 so that at least portion of opening 110 is exposed. Axis 312 may be perpendicular to fan modules 302-304 and/or as an 306. At least a cable 314 may be passed through the exposed portion of opening 110 from the back side of thermal management door assembly 100 to the front side of thermal management door assembly 100. Cable 314 may be plugged into an electrical connector 316 of a computing device. After cable 314 passes through opening 110, sealing door 104 may slide down to rest on top of cable 314. Thus, the amount of exposed space in opening 110 may be controlled by a height or thickness of cable 314. Further, the amount of exposed space in opening 110 may also be reduced as comparing to keeping sealing door 104 at the same position after cable 314 has passed through opening 110.

FIG. 4 illustrates an amount of air recirculation when thermal management door assembly 100 of FIG. 1 with sealing door 104 in a closed position, according to an example. During operation, fan module 302 may draw in air via a first intake region 402 and expel the air into a chassis of a computing device via a first exhaust region 404. The air flow through fan module 302 may be indicated by arrows 406-408. Fan module 304 may also draw in air via a second intake region 410 and expel the air into the chassis via a second exhaust region 412. The air flow through fan module 304 may be indicated by arrows 414-416.

Some of the air flow through fan module 302 and/or some of the air flow through fan module 304 may spread or move towards exhaust regions 404 and 412 as indicated by arrows 418-420 (“outflow airflow”). When sealing door 104 is in the closed position, the recirculating airflow may be blocked by sealing door 104 and may not be recirculated by fan modules 302 and/304. Thus, the amount of air recirculation from exhaust regions 404 and 412 to intake regions 402 and 410 may be reduced.

The use of “comprising”, “including” or “having” are synonymous and variations thereof herein are meant to be inclusive or open-ended and do not exclude additional unrecited elements or method steps.

What is claimed is:

1. An apparatus comprising:
a first fan assembly including an intake region and an exhaust region;
a second fan assembly aligned with the first fan assembly; and
a thermal management door assembly positioned between the first fan assembly and the second fan assembly, wherein the thermal management door assembly includes:
a frame coupled to the fist n assembly and to the second fan assembly; and
a sealing door movably coupled to the frame to control an amount of air recirculation from the exhaust region to the intake region.

2. The apparatus of claim 1, wherein the sealing door is slidable with respect to an axis perpendicular to the first fan assembly.

3. The apparatus of claim 1, wherein the frame includes an opening, wherein the opening has a first amount of exposed space when the sealing door is in a first position, and wherein the opening has a second amount of exposed space different from the first amount of exposed space when the sealing door is in a second position.

4. The apparatus of claim 3, wherein the first fan assembly has a first amount of air recirculation when the sealing door is in the first position, and wherein the first fan assembly has a second amount of air recirculation greater than the first amount when the sealing door is in the second position.

5. The apparatus of claim 1, wherein the sealing doer is to change from a second position to a first position via gravitational force.

6. The apparatus of claim , further comprising a basepan housed in a chassis of a computing device, wherein the first fan assembly, the second fan assembly, and the thermal management door assembly are coupled to the basepan.

7. An apparatus comprising:
a basepan including a first pin and a second pin, wherein the first pin and the second pin extend from the basepan;
a first fan assembly coupled to the basepan via the first pin, wherein the first fan assembly includes an intake region and an exhaust region;
a second fan assembly coupled to the basepan via the second pin, wherein the second fan assembly is aligned with the first fan assembly; and
a thermal management door assembly coupled to the basepan via the first pin and the second pin, wherein the thermal management door assembly is positioned between the first fan assembly and the second fan assembly, and wherein the thermal management door is to control an amount of air recirculation from the exhaust region to the intake region.

8. The apparatus of claim 7, wherein the thermal management door assembly includes:
a frame including a first receptacle and a second receptacle, wherein the first receptacle is to receive the first pin, and wherein the second receptacle is to receive the second pin; and
a sealing door movably coupled to the frame, wherein the thermal management door assembly is to control the amount of air recirculation via the sealing door.

9. The apparatus of claim 8, wherein the sealing door is slidable with respect to an axis perpendicular to the first fan assembly.

10. The apparatus of claim 8, wherein the frame includes an opening, wherein the opening has a first amount of exposed space when the sealing door is in a first position, and wherein the opening has a second amount of exposed space different from the first amount of exposed space when the sealing door is in a second position.

11. The apparatus of claim 10, wherein the first fan assembly has a first amount of air recirculation when the sealing door is in the first position, and wherein the first fan assembly has a second amount of air recirculation greater than the first amount when the sealing door is in the second position.

12. An apparatus comprising:
a basepan including a first pin and a second pin, wherein the first pin and the second pin extend from the basepan;
a first fan assembly coupled to the basepan via the first pin, wherein the first fan assembly includes an intake region and an exhaust region;
a second fan assembly coupled to the basepan via the second pin, wherein the second fan assembly is aligned with the first fan assembly; and
a thermal management door assembly coupled to the basepan via the first pin and the second pin, wherein the thermal management door assembly is in physical contact with the first fan assembly and the second fan assembly, and wherein the thermal management door is to control an amount of air recirculation from the exhaust region to the intake region.

13. The apparatus of claim l2, wherein the thermal management door assembly includes:
a frame including a first receptacle and a second receptacle, wherein the first receptacle is to receive the first pin, and wherein the second receptacle is to receive the second pin: and
a sealing door movably coupled to the frame, wherein the thermal management door assembly is to control the amount of air recirculation via the sealing door.

14. The apparatus of claim 13, wherein the sealing door is slidable respect to an axis perpendicular to the first fan assembly.

15. The apparatus of claim 13 wherein the frame includes an opening, wherein the opening has a first amount of exposed space when the sealing door is in a first position, and wherein the opening has a second amount of exposed space different from the first amount of exposed space when the sealing door is in a second position.
